(19) United States
(12) Patent Application Publication
(10) Pub. No.: US 2012/0161729 A1
(43) Pub. Date: Jun. 28, 2012

(54) BUCK CONVERTER

(75) Inventors: SONG-LIN TONG, Shenzhen City (CN); QI-YAN LUO, Shenzhen City (CN); PENG CHEN, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD., Shenzhen City (CN)

(21) Appl. No.: 13/100,962

(22) Filed: May 4, 2011

(30) Foreign Application Priority Data
Dec. 22, 2010 (CN) 201010600698.2

(51) Int. Cl. G05F 1/618

(52) U.S. Cl. 323/272; 323/283

(57) ABSTRACT

A buck converter includes an input unit, an inductor, and a filter capacitor. The input unit has an input node connected to a power source and an intermediate node connected to an output node through the inductor. The filter capacitor is coupled between the output node and ground. A first RC integral circuit is in parallel connection with the first inductor, a voltage acquired unit is in parallel connection with the capacitor of the RC integral circuit for obtaining a voltage U1 between the two terminals of the second capacitor. A control unit is coupled to the first voltage acquired unit for receiving the voltage U1 of the capacitor.

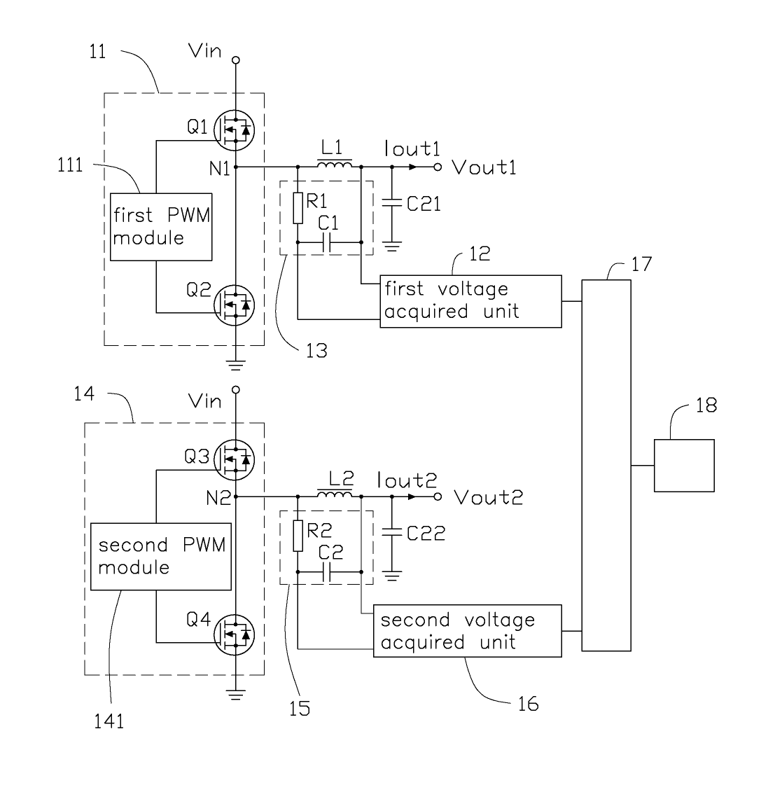

### BACKGROUND

1. Technical Field

The present disclosure relates to a buck converter.

2. Description of Related Art

In computer systems, buck converters are frequently used in power systems for a main board. In order to obtain a steady voltage, a high current and a low temperature, the buck converters may be multi-phase. However, if currents are not balanced, the buck converters may be damaged and fail.

What is needed therefore is a buck converter which can overcome the above limitations.

### BRIEF DESCRIPTION OF THE DRAWING

Many aspects of the present embodiments can be better understood with reference to the following drawing. The components in the drawing are not necessarily drawn to scale, the emphasis instead being placed upon clearly illustrating the principles of the present embodiments. Moreover, in the drawing, like reference numerals designate corresponding parts throughout the views.

The drawing is a schematic, block diagram of a buck converter in accordance with an embodiment of the present disclosure.

### DETAILED DESCRIPTION

As shown in the drawing, a buck converter in accordance with an embodiment of the present disclosure includes an input node Vin, a first input unit 11, a first voltage acquired unit 12, a first RC integral circuit 13, a second input unit 14, a second RC integral circuit 15, a second voltage acquired unit 16, a control unit 17, a display unit 18, a first output node Vout1, and a second output node Vout2. The input node Vin is adapted to connect to a power source, to receive power for the first input unit 11 and the second input unit 14.

The first input unit 11 includes a first pulse width modulation (PWM) module 111, a first metal oxide semiconductor field effect transistor (MOSFET) Q1, and a second MOSFET Q2. The first PWM module 111 is coupled to a gate of the first MOSFET Q1 and a gate of the second MOSFET Q2. The PWM module 111 provides gate drive signals to the gates of the first MOSFET Q1 and second MOSFET Q2 alternatively. The first MOSFET Q1 has a drain coupled to the input node Vin and a source coupled to a first intermediate node N1. The second MOSFET Q2 has a drain coupled to the first intermediate node N1 and a source coupled to a reference node, such as ground (GND). A first inductor L1 is coupled between the first intermediate node N1 and the first output node Vout1, and a first capacitor C21 is coupled between the first output node Vout1 and ground. The first inductor L1 and the first capacitor C21 are configured to output a direct current (DC) voltage at the first output node Vout1.

The first inductor L1 is in parallel connection with the first RC integral circuit 13. The first RC integral circuit 13 includes a first resistor R1 and a second capacitor C1. The first resistor R1 has a first terminal coupled to the first intermediate node N1 and a second terminal The second capacitor C1 has a first terminal coupled to the second terminal of the first resistor R1 and a second terminal coupled to the first output node Vout1. In this embodiment, the resistance of the first resistor R1 is 10 KΩ, and the second capacitor C1 has a capacitance of 1 μF.

The second input unit 14 includes a second PWM module 141, a third MOSFET Q3, and a fourth MOSFET Q4. The second PWM module 141 is coupled to a gate of the third MOSFET Q3 and a gate of the fourth MOSFET Q4. The third MOSFET Q3 has a drain coupled to the input node Vin and a source coupled to a second intermediate node N2. The fourth MOSFET Q4 has a drain coupled to the second intermediate node N2 and a source coupled to the ground. A second inductor L2 is coupled between the second intermediate node N2 and the second output node Vout2, and a third capacitor C22 is coupled between the second output node Vout2 and the ground. The second inductor L2 and the third capacitor C22 are configured to output a direct current (DC) voltage at the second output node Vout2.

The second inductor L2 is in parallel connection with the second RC integral circuit 15. The second RC integral circuit 15 includes a second resistor R2 and a fourth capacitor C2. The second resistor R2 has a first terminal coupled to the second intermediate node N2 and a second terminal. The fourth capacitor C2 has a first terminal coupled to the second terminal of the second resistor R2 and a second terminal coupled to the second output node Vout2. In this embodiment, the resistance of the second resistor R2 is 10 KΩ, and the fourth capacitor C2 has a capacitance of 1 μF.

The first voltage acquired unit 12 is in parallel connection with the second capacitor C1 for obtaining a voltage U1 from the second capacitor C1. The second voltage acquired unit 16 is in parallel connection with the fourth capacitor C2 for obtaining a voltage U2 from the fourth capacitor C2. The first voltage acquired unit 12 and the second voltage acquired unit 16 transmit the voltage U1 and the voltage U2 to the control unit 17. Values of equivalent resistances Rout1 and Rout2 are previously stored in the control unit 17. In this embodiment, the equivalent resistances Rout1 and Rout2 can be calculated in the following manner Firstly, make an output current Iout1 equal to 1 A and a first value U11 can be obtained from the second capacitor C1. Secondly, make an output current Iout1 equal to 10 A and a second value U12 can be obtained from the second capacitor C1. After that, the equivalent resistances Rout1 can be calculated as Rout1=(U12−U11)/(10−1). Take U11=0.5 mV; U12=3.2 mV for example, the equivalent resistances Rout1 is 0.3 mΩ. Therefore, when different loads are connected to the first output node Vout1, the first output current Iout1 can be calculated as Iout1=U1/Rout1. Similarly, the equivalent resistances Rout2 can also be obtained in the manner described above and the second output current Iout2 can be calculated as Iout2=U2/Rout2. After that, the control unit 17 will transmit the values of the output current Iout1 and the output current Iout2 to the display unit 18. In other embodiments, different values of the first output current Iout1 or the second output current Iout2 can be used to calculate the equivalent resistances Rout1 and Rout2.

It is believed that the present embodiments and their advantages will be understood from the foregoing description, and it will be apparent that various changes may be made thereto without departing from the spirit and scope of the disclosure or sacrificing all of its material advantages, the examples hereinbefore described merely being preferred or exemplary embodiments of the disclosure.

What is claimed is:

1. A buck converter, comprising:
a first input unit having a first intermediate node and a first input node connected to a power source;
a first inductor being coupled between the first intermediate node and a first output node;
a first capacitor being coupled between the first output node and ground;
a first resistor-capacitor (RC) integral circuit being in parallel connection with the first inductor, the first RC integral circuit comprising a first resistor and a second capacitor, the first resistor having a first terminal coupled to the first intermediate node and a second terminal; the second capacitor having a first terminal coupled to the second terminal of the first resistor and a second terminal coupled to the first output node;
a first voltage acquired unit being in parallel connection with the second capacitor for obtaining a voltage U1 of the second capacitor; and
a control unit being coupled to the first voltage acquired unit for receiving the voltage U1 of the second capacitor.

2. The buck converter of claim 1, wherein an equivalent resistance Rout1 is previously storied in the control unit, the control unit calculates an output current Iout1 by using the formula Iout1=U1/Rout1.

3. The buck converter of claim 2, further comprising a display unit, the control unit being coupled to the display unit for transmitting the value of the current Iout1 to the display unit.

4. The buck converter of claim 1, wherein the first input unit comprises a first PWM module, a first MOSFET and a second MOSFET, the first PWM module is coupled to a gate of the first MOSFET and a gate of the second MOSFET, a drain of the first MOSFET is coupled to the input node and a source of the first MOSFET is coupled to the first intermediate node, a drain of the second MOSFET is coupled to the first intermediate node and a source of the second MOSFET is coupled to the reference node.

5. The buck converter of claim 1, further comprising a second input unit, a second inductor, a third capacitor and a second output node, the second input unit having a second input node connecting to the power source, and a second intermediate node; the second inductor being coupled between the second intermediate node and the second output node; the third capacitor being coupled between the second output node and the reference node.

6. The buck converter of claim 5, further comprising a second RC integral circuit in parallel connection with the second inductor and a second voltage acquired unit, the second RC integral circuit comprising a second resistor and a fourth capacitor, the second resistor having a first terminal coupled to the second intermediate node and a second terminal coupled to the fourth capacitor; the fourth capacitor having a first terminal coupled to the second resistor and a second terminal coupled to the second output node; the second voltage acquired unit being in parallel connection with the fourth capacitor for obtaining a voltage U2 between the two terminals of the fourth capacitor.

7. The buck converter of claim 6, wherein the control unit is coupled to the second voltage acquired unit for receiving the voltage U2 of the fourth capacitor.

8. The buck converter of claim 7, wherein an equivalent resistance Rout2 of the second inductor is previously storied in the control unit, the control unit calculates a current Iout2 by using the formula Iout2=U2/Rout2.

9. The buck converter of claim 8, further comprising a display unit, the control unit being coupled to the display unit for transmitting the current Iout2 to the display unit.

10. The buck converter of claim 5, wherein the second input unit comprises a second PWM module, a third MOSFET and a fourth MOSFET, the second PWM module is coupled to a gate of the third MOSFET and a gate of the fourth MOSFET, a drain of the third MOSFET is coupled to the input node and a source of the third MOSFET is coupled to the second intermediate node, a drain of the fourth MOSFET is coupled to the second intermediate node and a source of the fourth MOSFET is coupled to the reference node.
